(19) United States
(12) Patent Application Publication
(10) Pub. No.: US 2007/0216668 A1
(43) Pub. Date: Sep. 20, 2007

(54) Information terminal with image display apparatus

(76) Inventors: Mitsuhide Miyamoto, Kokubunji (JP); Mutsuko Hatano, Kokubunji (JP); Hajime Akimoto, Kokubunji (JP); Kazuki Watanabe, Hino (JP); Kouichi Uesaka, Yokohama (JP)

Correspondence Address: REED SMITH LLP, Suite 1400, 3110 Fairview Park Drive, Falls Church, VA, 22042, US

(21) Appl. No.: 11/704,187

(22) Filed: Feb. 9, 2007

(30) Foreign Application Priority Data
Mar. 14, 2006 (JP) 2006-068610

(51) Int. Cl. G09G 5/00

(52) U.S. Cl. 345/204

(57) ABSTRACT

Disclosed herewith is an information terminal provided with a function for displaying image data. An electromagnetic wave output from a main device provided outside the information terminal is received by an antenna and converted to a binary signal by a wave detection circuit. Using the signal obtained by this wave detection circuit, a power supply circuit generates a power for driving a processor, a memory, a display part, a data line driving signal, a data line driving signal, and a timing controller. The processor decodes the signal received by the wave detection circuit and stores the received information in the memory. The timing controller generates control signals of the data line driving circuit and the scanning line driving circuit, as well as image data so as to display images on the display part.

### CLAIM OF PRIORITY

The present application claims priority from Japanese application JP 2006-068610 filed on Mar. 14, 2006, the content of which is hereby incorporated by reference into this application.

### FIELD OF THE INVENTION

The present invention relates to an information terminal, more particularly to an information terminal provided with an image display device for receiving image data from a main device as an electromagnetic wave and displaying received image data.

### BACKGROUND OF THE INVENTION

The use of various portable type information terminals have spread in recent years. They are typically such non-contact IC cards as Felica and ID cards used for data communications with use of RF signals. A non-contact IC card includes an antenna, a receiving circuit, and a memory that are all built in itself. The non-contact IC card can send/receive data to/from a reader/writer (main device) as an electromagnetic wave. Unlike each of conventional magnetic cards that must be inserted into a magnetic card reader to read data therefrom, this non-contact IC card is free of such troublesome operations. Thus the non-contact IC card is expected to be more improved in usability.

In order to improve the usability of such non-contact IC cards, another type card is proposed recently. An image display element is added to the card. For example, JP-A No. 13481/2006 discloses a configuration of such a new IC card that includes an RF transmission/receiving circuit formed on a TFT substrate and the circuit is combined with such a display element as a liquid crystal. If such an IC card is further added a display function, received data can be visualized immediately to improve the user friendly services significantly.

### SUMMARY OF THE INVENTION

In case where an image display element (image display device) is added to a non-contact IC, the card usability will be improved as described above. However, in order to realize such an IC card, there are some problems that must be solved. For example, one of the problems is how such different functions as data transmission/receiving and image displaying are combined. Furthermore, how the whole configuration of the IC card is determined, how individual functions of the IC card are realized, how the IC card is manufactured, etc. are other problems that must also be solved.

Among those conventional problems, the present inventor has come to pay attention to an interface part between the data transmission/receiving part and the image display part. In other words, the present inventor has found that any of conventional techniques has given no consideration to the signal processings of how control signals and image signals are generated from received signals.

Under such circumstances, it is an object of the present invention to provide an information terminal provided with an image display device for displaying image data received as an electromagnetic wave.

The information terminal of the present invention is provided with an image display device that includes an antenna, a wave detection circuit, a timing controller, a display part, and a display part driving circuit. To display data received by the antenna on the display part as an image, the timing controller generates a control signal synchronized with both image signal and header signal received by the antenna and detected by the wave detection circuit and sends the control signal to the display part control circuit.

Each of the wave detection circuit, the timing controller, the image display part, the display part control circuit, etc. is composed of thin film transistors formed on a substrate of the image display device. The timing controller converts image signals received by the antenna to NRZ signals. The timing controller also converts the amplitude of each received signal to a voltage level of image data, then sends the voltage to the display part. The display part control circuit is composed of a data line driving circuit for driving data lines of the image display part and a scanning line driving circuit for driving scanning lines of the image display part. Each of the driving circuits includes one or more shift registers and those registers are connected so as to drive predetermined data and scanning lines respectively. Consequently, a predetermined one of those shift registers is driven to display an image on a predetermined position in the display part.

The display part is composed of a plurality of pixels and each of the pixels has a memory function so that received image data can be kept displayed even after image data receiving is ended.

Each signal received by the antenna is added a header for indicating the subject image data and another header for indicating a position of the image data on the display part, thereby the image display device can recognize each image display position on the image display part.

The display device can also generate a power from the received electromagnetic wave as an internal power supply, thereby the portable type information terminal of the present invention does not need any external power supply.

An information terminal, when it is provided with an image display device of the present invention, therefore, can realize a display device having communication functions for receiving an electromagnetic wave from external, generating image signals, as well as image displaying control signals and image data from received signals, then displaying images.

### BRIEF DESCRIPTION OF THE DRAWINGS

FIG. 1 is a block diagram of a configuration of an information terminal provided with an image display device of the present invention in a first embodiment;

FIG. 2 is a diagram of a waveform detected by a wave detection circuit shown in FIG. 1;

FIG. 3 is a diagram for showing a configuration of each of a display part, a data line driving circuit and a scanning line driving circuit shown in FIG. 1, as well as an example of input signals;

FIG. 4 is an example of waveforms of control signals shown in FIG. 1;

FIG. 5 is a block diagram of an information terminal provided with an image display device of the present invention in a second embodiment;

FIG. 6 is a block diagram of an information terminal provided with an image display device of the present invention in a third embodiment;

FIG. 7 is a configuration of each of an image data memory, a display part, a data line driving circuit, and a scanning line driving circuit in the third embodiment of an information terminal provided with an image display device of the present invention;

FIG. 8 is an internal block diagram of a timing controller in a fourth embodiment of an information terminal provided with an image display device of the present invention;

FIG. 9 is a diagram for showing waveforms of an input signal, an NRZ signal, and a clock of a timing controller;

FIG. 10 is a configuration of each of a display part, a data line driving circuit, and a scanning line driving circuit in a fifth embodiment of an information terminal provided with an image display device of the present invention;

FIG. 11 is a configuration of received data in a sixth embodiment of an information terminal of the present invention;

FIG. 12 is a configuration of received data in a seventh embodiment of an information terminal of the present invention;

FIG. 13 is a configuration of received data in an eighth embodiment of an information terminal of the present invention; and

FIG. 14 is a structure of a pixel in a ninth embodiment of an information terminal of the present invention.

### DETAILED DESCRIPTION OF THE PREFERRED EMBODIMENTS

Hereunder, a description will be made in detail for an information terminal provided with an image display device of the present invention with reference to the accompanying drawings. In the accompanying drawings, the same reference numerals will be used for the same and similar components, avoiding redundancy.

### First Embodiment

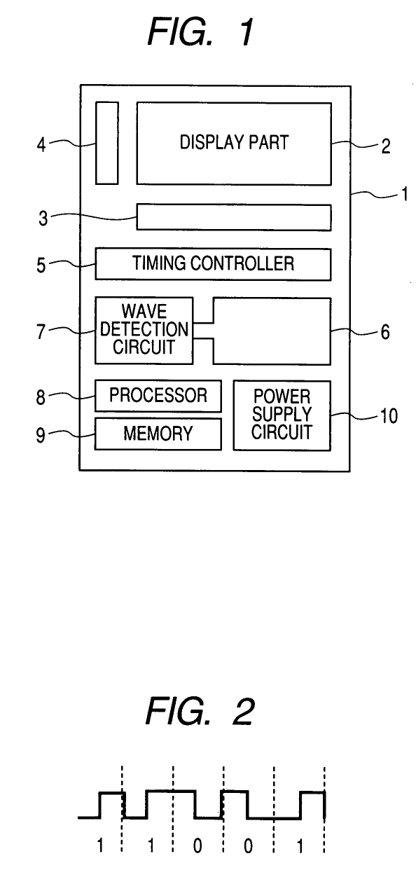

FIG. 1 shows a configuration of a first embodiment of the present invention. An information terminal 1 provided with an image display device is composed of a display part 2, a data line driving circuit 3, a scanning line driving circuit 4, a timing controller 5, an antenna 6, a wave detection circuit, a processor 8, a memory 9, and a power supply circuit 10 that are all incorporated in itself. The display part 2 is composed of a liquid crystal, an electron paper, an organic EL, etc.

Next, the operation of the information terminal 1 will be described. At first, input data is received by the antenna 6 as an electromagnetic wave from the main device provided outside the information terminal 1, then converted to a binary signal by the wave detection circuit 7. This binary signal uses, for example, the Manchester signal format as shown in FIG. 2. The signal obtained from the wave detection circuit 7 is used for the power supply circuit 10 to generate a power for driving the processor 8, the memory 9, the display part 2, the data line driving signal 3, the data line driving signal 4, and the timing controller 5. This power supply circuit 10 can also generate a power with use of a solar cell battery, or the like. The processor 8 decodes each signal received by the wave detection circuit 7 and stores the received information in the memory 9. Each signal stored in the memory 9 is output to (the main device) provided outside the information terminal 1 as an electromagnetic wave with use of the antenna 6.

After that, the timing controller 5 generates control signals of the data line driving circuit 3, control signals of the scanning line driving circuit 4, and image data from binary signals generated in the wave detection circuit 7. The control signals of the data line driving circuit 3 and the scanning line driving circuit 4 are synchronized with image data signals. Image data are obtained by converting signals detected by the wave detection circuit 7 to NRZ signals, then converting their amplitude to image data signal amplitude.

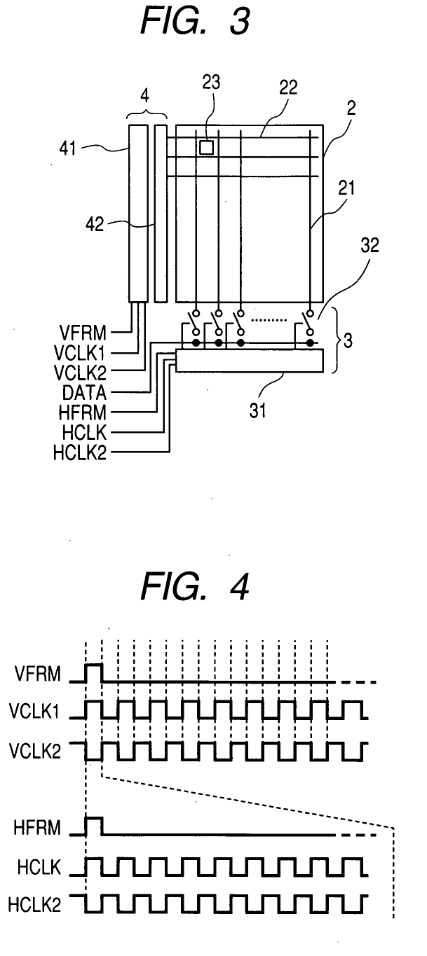

Next, a description will be made for examples of image data, as well as the control signals of the data line driving circuit 3 and the scanning line driving circuit 4, which are generated by the timing controller 5. FIG. 3 shows an example of a configuration of each of the display part 2, the data line driving circuit 3, and the scanning line driving circuit 4. In the display part are crossed a plurality of data lines 21 and a plurality of scanning lines 22. A pixel 23 is disposed at each intersection. The data line driving circuit 3 is composed of shift registers 31 and switches 32. Each shift register 31 inputs control signals HFRM, HCLK1, and HCLK2. On the other hand, the scanning line driving circuit 4 is composed of a shift register 41 and a level shifter 42. The shift register inputs control signals VFRM, VCLK1, and VCLK2. Image data DATA is connected to all the data lines 21 through switches 32.

FIG. 4 shows an example of the waveforms of the control signals VFRM, VCLK1, and VCLK2 inputted to the shift register 41, as well as the control signals HFRM, HCLK1, and HCLK2 inputted to the shift register 31. The VFRM is a start pulse of the shift register 41 and its level becomes High once at the first time between one-screen display periods. The shift register 41 transfers this VFRM signal to CLK1 and CLK2 to drive the scanning lines 22 sequentially.

The shift register 31 assumes the HFRM as a starting pulse and transfers the signal to HCLK1 and HCLK2 to drive the switches 32 sequentially. When the switches 32 are driven such way, image data DATA is transferred to one of the data lines 21, corresponding to the driven switch 32. The switches 32 are driven in a time division manner in a period in which one scanning line is selected, thereby transferring image data DATA to each pixel 23 provided in one line in the display part 2. This image data transferring is synchronized with the binary signal output from the wave detection circuit 7. Thus the image display device can display signals as an electromagnetic wave from outside of the information terminal 1 on the display part sequentially.

Signals output from the wave detection circuit 7 are converted to NRZ signals and the amplitude of those signals is converted appropriately to that for image data, thereby each received signal value 1/0 represents bright/dark or dark/bright of each pixel of the display part. Thus image data is displayed sequentially on the display part. If the display part employs a segment display method, each received signal is written in each segment sequentially.

The circuits described above may be divided so that each of them is manufactured separately with an LSI, with thin film transistors, and particularly with low temperature polysilicon thin film transistors. In case where all those circuits are formed with thin film transistors, they can be manufactured on the substrate of the image display device in the same process, thereby reduction of the manufacturing cost can be expected. Furthermore, in case where the thin transistors are manufactured with use of a printing technique, the reduction of the manufacturing cost can further be realized. And if thin film transistors are formed on a flexible substrate to manufacture the image display device of the present invention, the usability of the image display device will be more improved.

### Second Embodiment

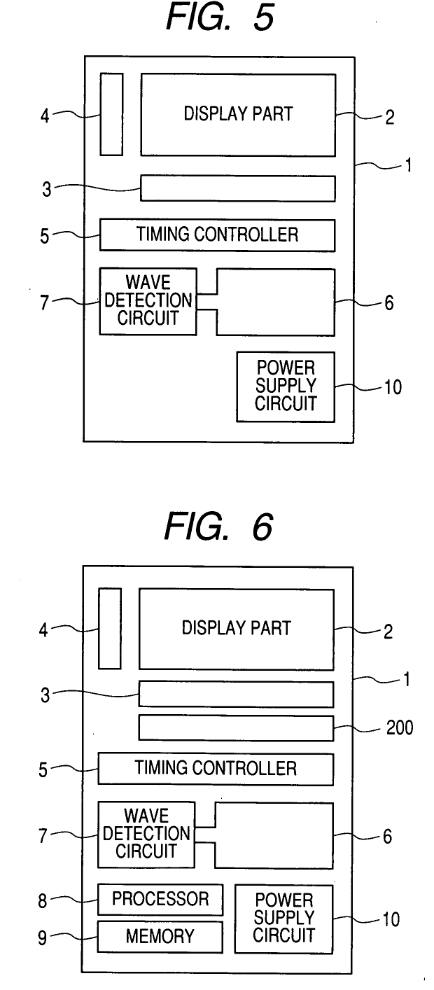

FIG. 5 shows a configuration of a second embodiment of the present invention. In FIG. 5, an information terminal 1 provided with an image display device incorporates a display part 2, a data line driving circuit 3, a scanning line driving circuit 4, a timing controller 5, an antenna 6, a wave detection circuit 7, and a power supply circuit 10. In this second embodiment, the information terminal 1 does not include the processor 8 and the memory 9 that are included in the first embodiment. And the image display device includes only a function for displaying an electromagnetic wave received by the antenna 6.

Just like the configuration in the first embodiment, described with reference to FIG. 1, if all the circuits are composed of thin film transistors in this second embodiment, reduction of the manufacturing cost can be expected. Furthermore, those thin film transistors are formed with a printing technique, reduction of the manufacturing cost is more expected. And if thin film transistors are formed on a flexible substrate to manufacture the image display device of the present invention, the usability of the image display device will be more improved.

### Third Embodiment

FIG. 6 shows a configuration of a third embodiment of the present invention. In FIG. 6, an information terminal 1 provided with an image display device incorporates a display part 2, a data line driving circuit 3, a scanning line driving circuit 4, a timing controller 5, an antenna 6, a wave detection circuit 7, a processor 8, a memory 9, a power supply circuit 10, and an image data memory 200. The image data memory 200 provided for the information terminal 1 in this third embodiment is only a difference from the first embodiment described with reference to FIG. 1.

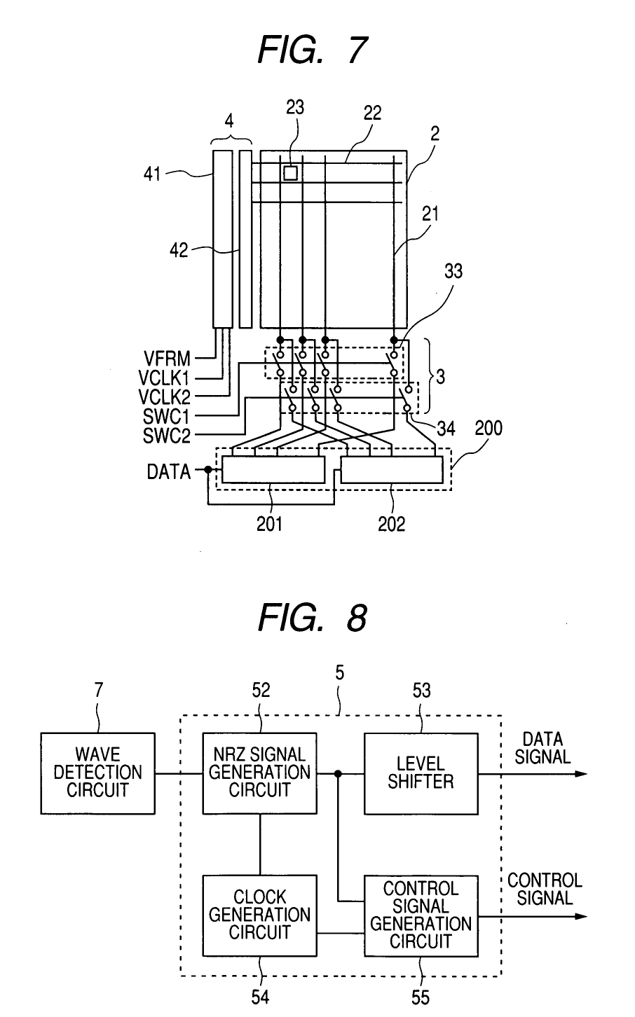

FIG. 7 shows a configuration of each of the image data memory 200, the display part 1, the data line driving circuit 3, and the scanning line driving circuit 4 in this embodiment. The image data memory 200 is composed of a first image data memory 201 and a second image data memory 202. The first and second image data memories 201 and 202 store a line of image data of the display part 2 alternately. The first and second image data memories 201 and 202 are connected to data lines 21 through switches 33 and 34 respectively and the switches 33 and 34 are controlled by signals SWC1 and SWC2 respectively. In this configuration, each time one scanning line 22 is selected, data from the first and second image data memories 201 and 202 are transferred to the data lines 21 alternately, thereby data is stored in each pixel 23 to display images.

Just like the configuration in the first embodiment, described with reference to FIG. 1, if all the circuits are composed of thin film transistors in this third embodiment, reduction of the manufacturing cost can be expected. Furthermore, if those thin film transistors are formed with a printing technique, reduction of the manufacturing cost is more expected. And if thin film transistors are formed on a flexible substrate to manufacture the image display device of the present invention, the usability of the image display device will be more improved.

### Fourth Embodiment

Next, an internal configuration of the timing controller 5 will be described. FIG. 8 shows an internal block diagram of the timing controller 5. The timing controller 5 is composed of an NRZ signal generation circuit 52, a level shifter 53, a clock generation circuit 54, and a control signal generation circuit 55.

The NRZ signal generation circuit 52 converts each output of the wave detection circuit 7 as shown in FIG. 2 to an NRZ signal. The level shifter 53 converts the amplitude of the NRZ signal to an image data signal amplitude. If the amplitude of the output signal of the NRZ signal generation circuit 52 is already the image data signal amplitude, this level shifter 53 can be omitted. The clock signal generation circuit 53 generates a clock synchronized with the output of the wave detection circuit 7 from the output of the NRZ signal generation circuit 52. The control signal generation circuit 55 generates control signals as shown in FIG. 4 from the output of the NRZ signal generation circuit and the output of the clock generation circuit 53 respectively.

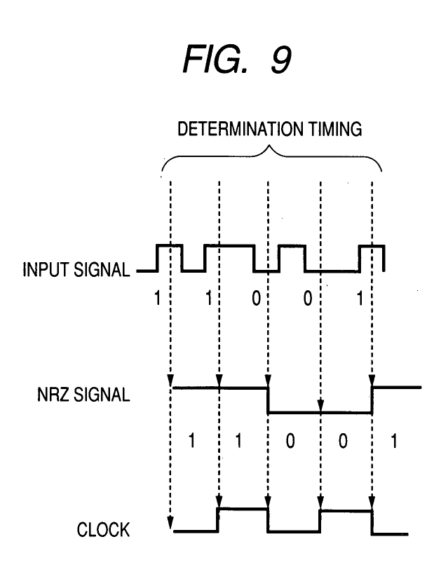

Here, a description will be made for an example of how the NRZ signal generation circuit and the clock generation circuit 53 provided in the timing controller 5 respectively generate signals with reference to FIG. 9. FIG. 9 shows input signals according to the Manchester method in the top step, NRZ signals in the middle step, and clocks in the bottom step. The NRZ signal generation circuit 52 determines an input signal at a determination timing shown with a dotted line in FIG. 9 and outputs the signal having a value 1 or 0. The clock generation circuit 53 generates a signal of which value (1/0) is inverted (0/1) at the same determination timing. This determination timing is generated by counting the number of carrier waves received by the antenna.

Next, a description will be made for an example of how the control signal generation circuit 55 generates signals. The driving signal generation circuit described here is, for example, a circuit for generating signals for driving the data line driving circuit 3 and the scanning line driving circuit 4 shown in FIG. 3. The control signal generation circuit 55 generates 6 signals VFRM, VCLK1, VCLK2, HFRM, HCLK1, and HCLK2. The HCLK1 and HCLK2 are a clock signal generated by the clock generation circuit 53 and its inverted signal. The HFRM signal indicates start of writing of one line on the display part shown in FIG. 3. This signal is generated by detecting the head of a line from an NRZ signal. The VCLK1 and VCLK2 are clock signals that are alternated each time the head of a line is detected from an NRZ signal. The VFRM is a signal for starting display of one screen on the display part 2. The VFRM signal is generated when the head of one screen is detected from an NRZ signal.

### Fifth Embodiment

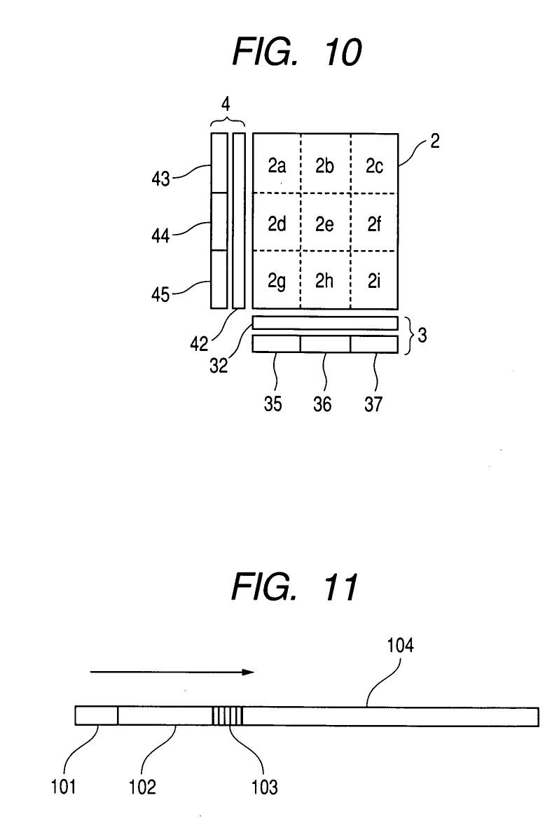

Hereunder, a fifth embodiment of the present invention will be described with reference to FIG. 10. FIG. 10 shows a configuration of each of a display part 2, a data line driving circuit 3, and a scanning line driving circuit 4 included in an information terminal 1 provided with an image display device. The data line driving circuit 3 is composed of first shift registers 35 to 37, and a switch 32. The scanning line driving circuit 4 is composed of second shift registers 43 to 45, and a level shifter 42. Each of the data line driving circuit 3 and the scanning line driving circuit 4 includes three shift registers, but the number of shift registers is not limited only to 3; it is just required to be more than one.

Because each of the data line driving circuit 3 and the scanning line driving circuit 4 shown in FIG. 10 includes three shift registers as described above, the display unit 2 is divided into nine blocks. Those nine blocks are shown in FIG. 10 as display parts 2a, 2b, 2c, 2d, 2e, 2f, 2g, 2h, and 2i. Because each of the display part 2, the data line driving circuit 3, and the scanning line driving circuit 4 is configured such way, any given one of those nine display parts can be used to display images. To display an image on a given display part, any one of the first and second shift registers 33 to 35 and 45 to 47 is driven.

To drive a given one of the shift registers described above, the timing controller 5 supplies a driving signal only to a predetermined shift register. At that time, the timing controller 5 needs image data, as well as position information on the display part 2 as input signals. Hereunder, an example of how such position information on the display part 2 is inputted will be described as a sixth embodiment.

### Sixth Embodiment

In the case of a non-contact IC card reader/writer having been used conventionally, a header is added to the head of data to be sent as an electromagnetic wave. The header is used to detect a start of data. In the same way, such a header for detecting a start of data is also needed for each signal inputted to the information terminal of the present invention as an electromagnetic wave. According to the present invention, besides the header, another header for image data is also needed. The header is used to determine whether or not a received signal is image data. FIG. 11 shows an example of a configuration of data received by the information terminal of the present invention in the sixth embodiment.

In FIG. 11, received data is composed of a header 101, data 102 other than image data, an image data header 103, and image data 104. Data is sent from left to right along an arrow shown in FIG. 11. If the data shown in FIG. 11 is inputted to the information terminal 1 shown in FIG. 1, the received signal is detected as binary data by the antenna 6 and the wave detection circuit 7 respectively. At that time, if the timing controller 5 detects an input of an image data header 103, the timing controller 5 outputs a control signal and image data shown in FIG. 3. If there is no data except for image data as shown in FIG. 11, the header 101 may be used as an image data header.

### Seventh Embodiment

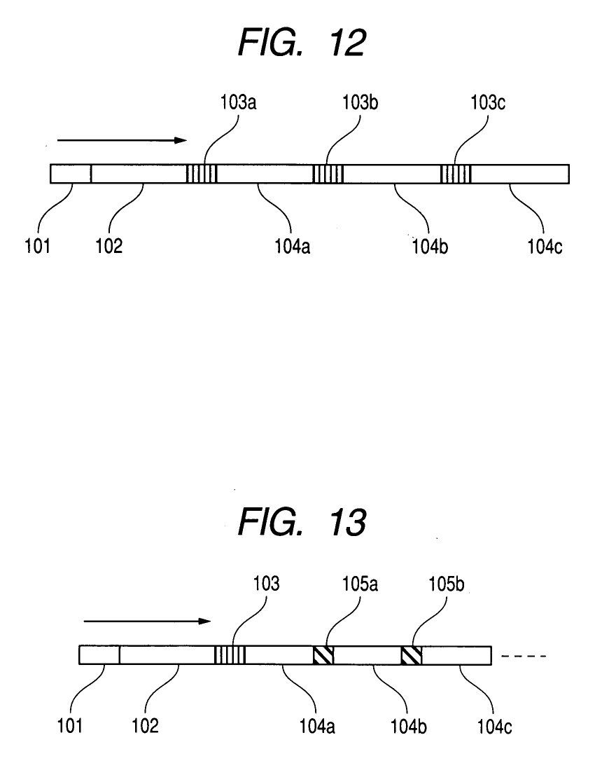

FIG. 12 shows another configuration of data received by an information terminal of the present invention in a seventh embodiment. In FIG. 12, transmission data is composed of a header 101, data 102 other than image data, an image data header 103a, image data 104a, an image data header 103b, image data 104b, an image data header 103c, and image data 104c. Data is sent from left to right along an arrow shown in FIG. 12. This data, for example, shown in FIG. 11 corresponds to data used to display images on three display parts 2b, 2e, and 2h. The image data header 103a is a header for displaying an image on the display part 2a. The timing controller 5, when detecting this header, drives the shift registers 36 and 43 shown in FIG. 10. Similarly, the timing controller 5, when detecting the image data header 103b, drives the shift registers 36 and 44 and when detecting the image data header 103c, drives the shift registers 36 and 45.

### Eighth Embodiment

FIG. 13 shows still another configuration of data sent out from an information terminal in an eighth embodiment of the present invention. In this eighth embodiment, received data is composed of a header 101, data 102 other than image data, an image data header 103, image data 104a, a line head header 105a, image data 104b, a line head header 105b, and image data 104c that are arranged sequentially. Data is sent from left to right along an arrow shown in FIG. 13. In this data configuration, for example, when the display part shown in FIG. 3 displays an image, a line change is recognized by the line head header, so that the timing controller 5 determines this line head header to start displaying of image data in pixels of the next line in the display part 2.

### Ninth Embodiment

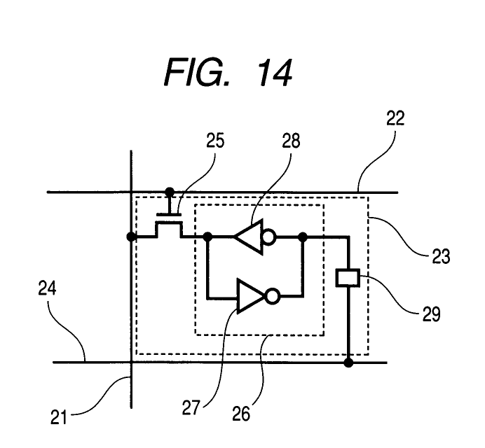

The display part 2 of the information terminal 1 provided with the image display device of the present invention is composed of a liquid crystal, an electron paper, an organic EL, etc. If each pixel in this display part 2 has a memory function for storing image data, image display can be continued. In this ninth embodiment, a description will be made for an example in which each pixel of the information terminal provided with an image display device has a memory function with reference to FIG. 14. FIG. 14 shows a pixel 23 of a liquid crystal, which has an SRAM type memory 26 in it. The pixel 23 fetches image data inputted from a data line 21 through a transistor 25. Here, a memory 26 consisting of inverters 27 and 28 is inserted between a transistor 25 and a liquid crystal element 29. Images can thus be kept displayed due to this memory 26 even after image data input is ended. In FIG. 14, a signal applied on top of the liquid crystal element 29 is a signal obtained by inverting image data received from a data line 21 and a difference between this signal and a voltage of a counter electrode 24 is applied to the liquid crystal element 29.

What is claimed is:

1. An information terminal comprising:
an image display device that includes a display part for displaying an image;
a display part driving circuit for driving said display part; and
a timing controller for supplying a control signal to said display part driving circuit,
wherein said information terminal includes an antenna for receiving an electromagnetic wave from external and a wave detection circuit for detecting a signal included in said electromagnetic wave received by said antenna, and
wherein said timing controller, when said detected signal includes an image signal and a header signal, supplies a control signal synchronized with said image signal and said header signal to said display part driving circuit so that said image signal is displayed on said display part.

2. The information terminal according to claim 1,
wherein said display part, said display part driving circuit, said timing controller, and said wave detection circuit are composed of thin film transistors respectively.

3. The information terminal according to claim 1,
wherein said timing controller includes an NRZ signal generation circuit for converting an image signal received by said antenna to an NRZ signal, a level shifter for converting said NRZ signal to a voltage used as data for displaying an image, a clock generation circuit for generating a clock synchronized with an output of said wave detection circuit from an output of said NRZ signal generation circuit, and a control signal generation circuit for generating a display control signal of said image display device, and
wherein said display device displays an image signal received by said antenna on said display part by supplying said display control signal to said display part.

4. The information terminal according to claim 3,
wherein said timing controller includes a memory for storing an output of said wave detection circuit and stores an image signal received by said antenna and converted to said NRZ signal once, then supplies said image signal to said display part at a predetermined timing, thereby a signal received by said antenna is displayed on said display part.

5. The information terminal according to claim 1,
wherein header data for indicating that said received signal is image data is added to said image data received by said antenna and said image data display starts when said header data is detected.

6. The information terminal according to claim 1,
wherein said display part is composed of a plurality of data lines for transferring image data, a plurality of scanning lines disposed so as to cross said plurality of data lines respectively, and a plurality of pixels corresponding to intersecting points of said plurality of data lines and said plurality of scanning lines respectively,
wherein said display part driving circuit includes a data line driving circuit for driving said plurality of data lines and a scanning line driving circuit for driving said plurality of scanning lines,
wherein said data line driving circuit includes a plurality of first shift registers, each selecting one of said plurality of data lines, and
wherein said scanning line driving circuit includes a plurality of second shift registers, each selecting one of said plurality of scanning lines.

7. The information terminal according to claim 6,
wherein header data for indicating a position on said display part, at which displaying is started with said received signal, is added to image data received by said antenna, and
wherein said image display device, when detecting said header data, drives one of said plurality of first and second shift registers, which corresponds to a predetermined position of said display, to start displaying of data image data at said predetermined position of said display part.

8. The information terminal according to claim 7,
wherein said image data is divided into a plurality of single line image data and header data for indicating the head of each line is added to the head of each line image data, and
wherein said image display device, when said header data is detected, changes lines for supplying image data to said display part.

9. The information terminal according to claim 1,
wherein said display part is composed of a plurality of pixels disposed like a matrix, and
wherein each of said plurality of pixels includes a memory element for storing image data.
